(19) United States
(12) Patent Application Publication
(10) Pub. No.: US 2011/0303001 A1
(43) Pub. Date: Dec. 15, 2011

(54) ROTARY ANGLE AND ROTARY TORQUE SENSING DEVICE

(75) Inventors: SHINJI HIROSE, Osaka (JP); KIYOTAKA SASANOUCHI, Osaka (JP)

(73) Assignee: PANASONIC CORPORATION, Osaka (JP)

(21) Appl. No.: 13/156,424

(22) Filed: Jun. 9, 2011

(30) Foreign Application Priority Data
Jun. 14, 2010 (JP) 2010-134765

(51) Int. Cl. G01M 17/06

(52) U.S. Cl. 73/117.02

(57) ABSTRACT

A rotary angle and rotary torque device includes a rotary torque sensor for sensing rotary torque of a steering shaft, a first magnet, a first magnetism sensing element, a sensing gear engaged with a rotary gear, a second magnet mounted to the sensing gear, a second magnetism sensing element, and a controller. The rotary torque sensor includes a first rotator and a second rotator either one of which has the rotary gear. The first rotator rigidly adheres to the second rotator via a coupler. The first magnet is mounted to either one of the first rotator or the second rotator. The first magnetism sensing element faces the first magnet, and the second magnetism sensing element faces the second magnet. The controller senses a rotary angle based on signals supplied from the first and the second magnetism sensing elements.

### TECHNICAL FIELD

The technical field relates to a rotary-angle and rotary-torque sensing device to be used for sensing a rotary angle and rotary torque of a steering shaft of an automobile.

### BACKGROUND

In recent years the automobile has become sophisticated, which entails incremental use of a variety of rotary torque sensors or rotary angle sensors for sensing rotary torque or a rotary angle of a steering shaft in order to control a power steering device or a braking device.

One of the foregoing conventional rotary angle and rotary torque sensing devices is described hereinafter with reference to FIGS. 11 and 12 which are a sectional view and an exploded perspective view of this conventional device. The conventional device shown in FIGS. 11 and 12 comprises the following elements:
first rotator 1, holder 2, magnet 3, second rotator 4, first magnetic body 5, second magnetic body 6, spacer 7, printed circuit board 8, first magnetism sensing element 9, controller 10, coupler 11, rotary gear 12, first sensing gear 13, second sensing gear 14, magnet 15A, second magnetism sensing element 15B, magnet 16A, and third magnetism sensing elements 16B.

First rotator 1 is shaped like a cylinder and rotates together with the steering shaft. Holder 2 is shaped like a cylinder and an upper section of the outer wall of holder 2 rigidly adheres to an upper section of the inner wall of first rotator 1. Magnet 3 is shaped like a ring where multiple N-poles and S-poles are alternately and adjacently arrayed. Magnet 3 rigidly adheres to a lower end of the outer wall of holder 2.

Second rotator 4 is shaped like a cylinder and is placed below first rotator 1. First rotator 1 connected to second rotators 4 via coupler 11, which is shaped like a cylinder and forms a torsion bar.

First magnetic body 5 is shaped like a ring and has multiple projections 5A on its inner wall, and second magnetic body 6 is also shaped like a ring and has multiple projections 6A on its inner wall. First magnetic body 5 confronts second magnetic body 6, and these two magnetic bodies rigidly adhere to an upper section of second rotator 4 such that they confront the outer wall of magnet 3 via spacer 7 with a given space from the outer wall of magnet 3.

Printed circuit board 8 is placed beside and substantially in parallel with first rotator 1 and second rotator 4, and has multiple wiring patterns on both the faces. First magnetism sensing element 9 formed of a Hall element is mounted on printed circuit board 8 such that element 9 is situated between first magnetic body 5 and second magnetic body 6 and confronts magnet 3. Controller 10 is mounted on printed circuit board 8 and connected to first magnetism sensing element 9. Controller 10 is formed of electronic components such as a microprocessor. The rotary torque sensor is thus formed.

Rotary gear 12 is formed on second rotator 4 at an underside of the outer wall of rotator 4, and mates with first sensing gear 13, which then mates with second sensing gear 14. First sensing gear 13 has the number of teeth different from that of second sensing gear 14.

Magnets 15A and 16A are mounted at the center of first sensing gear 13 and at the center of second sensing gear 14 respectively by insert-molding. Printed circuit board 8 is placed beside and in parallel with those first and second sensing gears 13 and 14. Printed circuit board 8 includes second magnetism sensing element 15B confronting magnet 15A, and third magnetism sensing element 16B confronting magnet 16A. Both of magnetism sensing elements 15B and 16B are formed of AMR (anisotropic magnetic resistance).

The rotary angle sensor is thus formed of rotary gear 12, first sensing gear 13, second sensing gear 14, magnet 15A, second magnetism sensing element 15B, magnet 16A, and third magnetism sensing element 16B.

Second magnetism sensing element 15B and third magnetism sensing element 16B are connected to controller 10, thereby forming the rotary angle and rotary torque sensing device.

A steering shaft is mounted to first rotator 1 and second rotator 4, so that the rotary angle and rotary torque sensing device discussed above is mounted under a steering wheel of an automobile. Controller 10 is connected to an electronic circuit of the automobile via connectors and lead-wires.

With the foregoing structure, turning of the steering wheel entails rotation of first rotator 1. The rotation of first rotator 1 causes coupler 11 to twist, and then second rotator 4 starts rotating slightly behind first rotator 1.

For instance, smaller rotary torque is required for turning the steering wheel during a regular run of the automobile, so that the delay of second rotator 4 relative to first rotator 1 is small. To the contrary, greater rotary torque is needed during a halt of the automobile, so that second rotator 4 starts rotating with a greater delay relative to first rotator 1.

The rotations of first and second rotators 1 and 4 cause magnet 3 rigidly adhering to first rotator 1 to rotate, and also cause first and second magnetic body 5 and 6 to start rotating after a slight delay from magnet 3. Magnetism sensing element 9 senses, via first and second magnetic body 5 and 6, variation in the magnetism radiated from magnet 3 which is formed of multiple N-poles and S-poles placed alternately and adjacently to each other, and then the sensed variation in the magnetism is supplied from magnetism sensing element 9 to controller 10.

At this time, first magnetism sensing element 9 senses weak magnetism when second rotator 4, to which first and second magnetic body 5 and 6 adhere, starts rotating after a small delay from first rotator 1. In other words, first magnetism sensing element 9 senses weak magnetism when rotary torque is small. On the other hand, sensing element 9 senses strong magnetism when second rotator 4, to which first and second magnetic body 5 and 6 adhere, starts rotating after a great delay from first rotator 1 to which magnet 3 adheres. In other words, first magnetism sensing element 9 senses strong magnetism when rotary torque is strong.

Based on the magnitude of the magnetism sensed via magnetic body 5 and 6 by sensing element 9, controller 10 calculates the rotary torque of first rotator 1, i.e. the rotary torque of the steering shaft. The calculated rotary torque is supplied from controller 10 to the electronic circuit of the automobile.

The rotation of second rotator 4 entails rotation of rotary gear 12 formed on rotator 4 at the underside of the outer wall of rotator 4, so that first sensing gear 13 mating with rotary gear 12 to rotate and also second sensing gear 14 mating with first sensing gear 13 to rotate. The rotations of gear 13 and gear 14 cause magnet 15A and magnet 16A mounted at the respective centers of gear 13 and gear 14 to rotate. The rotations of magnets 15A and 16A vary magnetic directions thereof, and then second magnetism sensing element 15B and third magnetism sensing element 16B sense these variations in magnetic direction. Variations in the sensed magnetism are supplied to controller 10 as angle-sensed signals in a shape of sine-wave, cosine-wave, or similar saw-tooth wave representing repeats of increment and decrement.

Since first sensing gear 13 has a different number of teeth from that of second sensing gear 14, the angle-sensed signal supplied from second magnetism sensing element 15B differs from the angle-sensed signal supplied from third magnetism sensing element 16B in shape and tilt angle of the data waveform. On top of that, there is a phase difference between these two signals, which are eventually supplied to controller 10.

Controller 10 carries out predetermined calculations to find rotary angles of rotary gear 12 and the steering shaft by using the foregoing angle-sensed signals and the numbers of teeth of respective gears. The calculation result is supplied to the electronic circuit of the automobile, and then the electronic circuit carries out calculations by using the rotary angles, rotary torque supplied from controller 10 and data supplied from velocity sensors mounted somewhere in the automobile, thereby controlling the power steering device, the braking device and others of the automobile.

The electronic circuit gains control of the braking device in response to the turning of the steering wheel based on the rotary angle supplied from controller 10. The electronic circuit also gains control of the force for turning the steering wheel.

### SUMMARY

A rotary angle and rotary torque device according to various embodiments include a rotary torque sensor for sensing the rotary torque of a steering shaft, a first magnet, a first magnetism sensing element, a sensing gear engaged with a rotary gear, a second magnet mounted to the sensing gear, a second magnetism sensing element, and a controller coupled to both of the first magnetism sensing element and the second magnetism sensing element.

The rotary torque sensor includes a first rotator and a second rotator, either one of which has the rotary gear. The first rotator rotates together with the steering shaft. The first rotator has a first connecting section to be connected to a coupler, and connected to the second rotator via the coupler. The second rotator has a second connecting section to be connected to the coupler. The first magnet is mounted to either one of the first rotator or the second rotator. The first magnetism sensing element faces the first magnet, and the second magnetism sensing element faces the second magnet. The first magnet and the second magnet are spaced out with a given space therebetween. The controller senses a rotary angle based on signals supplied from the first and the second magnetism sensing elements.

The structure discussed above allows the rotary angle and rotary torque sensing device to be downsized and to sense a rotary angle and rotary torque accurately without fail.

### BRIEF DESCRIPTION OF DRAWINGS

FIG. 1 is a sectional view of a rotary angle and rotary torque sensing device in accordance with an exemplary embodiment.

FIG. 2 is an exploded perspective view of a rotary angle and rotary torque sensing device in accordance with the exemplary embodiment.

FIG. 3 is a perspective view in part of a rotary angle and rotary torque sensing device in accordance with the exemplary embodiment.

FIG. 4A and FIG. 4B schematically illustrate a rotary angle and rotary torque sensing device in accordance with the exemplary embodiment.

FIG. 5 is a sectional view of a rotary angle and rotary torque sensing device in accordance with another exemplary embodiment.

FIG. 6 is a sectional view of a rotary angle and rotary torque sensing device in accordance with another exemplary embodiment.

FIG. 7 is an exploded perspective view of the rotary angle and rotary torque sensing device in accordance with the exemplary embodiment.

FIG. 8 is a sectional view of a rotary angle and rotary torque sensing device in accordance with another exemplary embodiment.

FIG. 9 is a sectional view of the rotary angle and rotary torque sensing device in accordance with the exemplary embodiment.

FIG. 10A and FIG. 10B are perspective views in part of a rotary angle and rotary torque sensing device in accordance with another exemplary embodiment.

FIG. 11 is a sectional view of a conventional rotary angle and rotary torque sensing device.

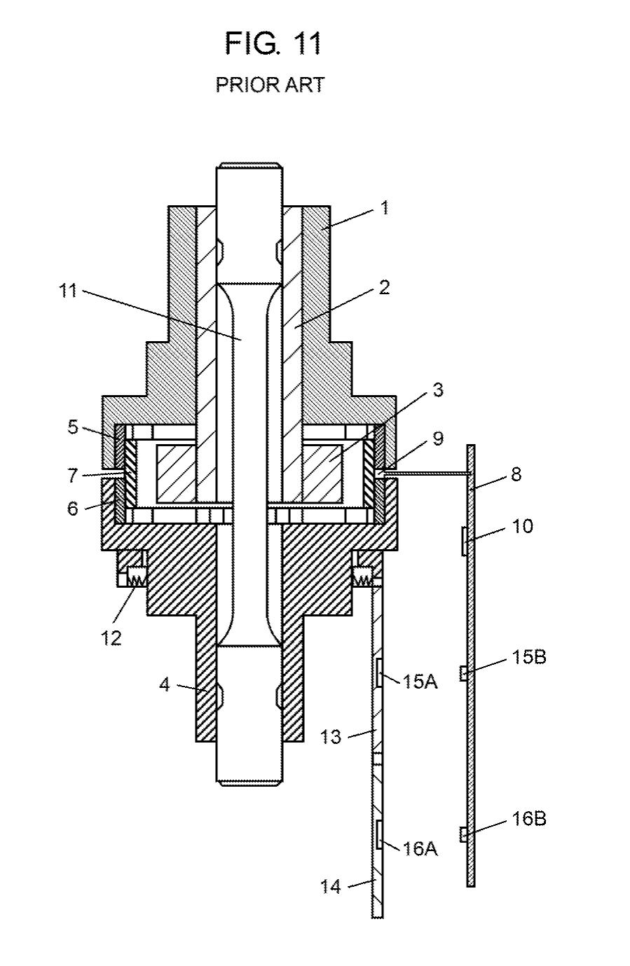

FIG. 12 is an exploded perspective view of the conventional rotary angle and rotary torque sensing device.

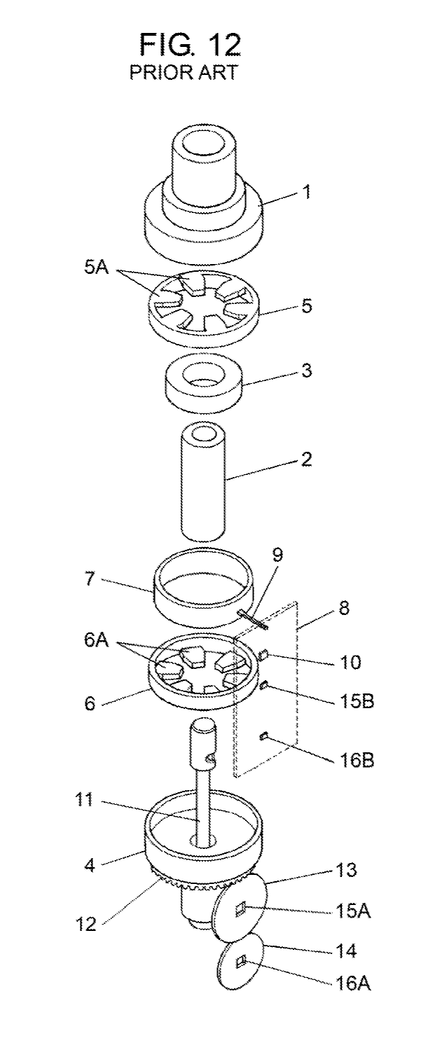

### PREFERRED EMBODIMENT

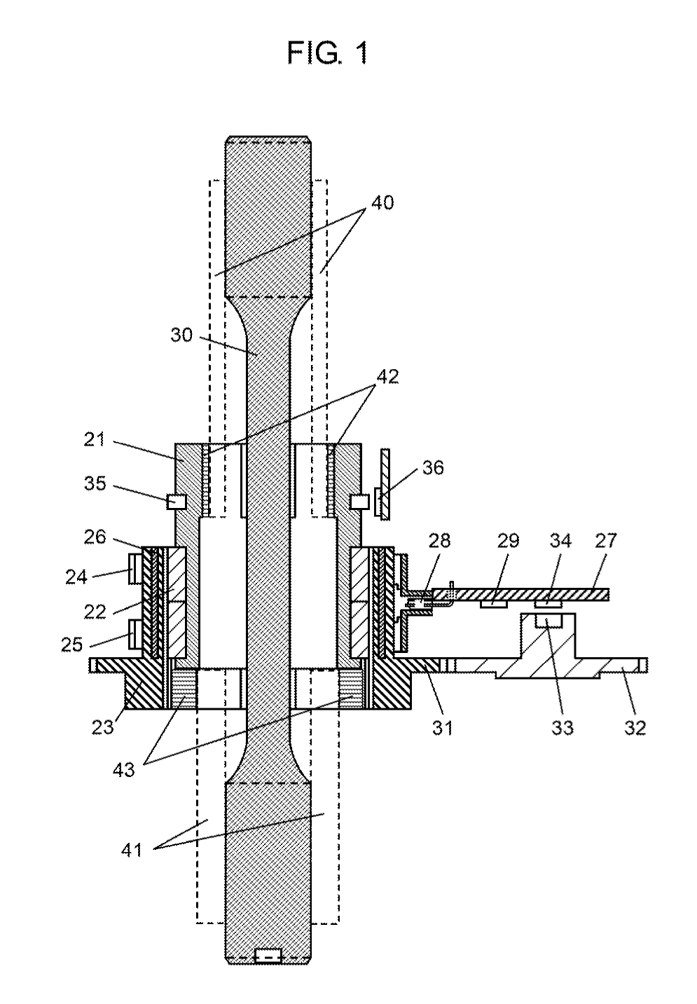

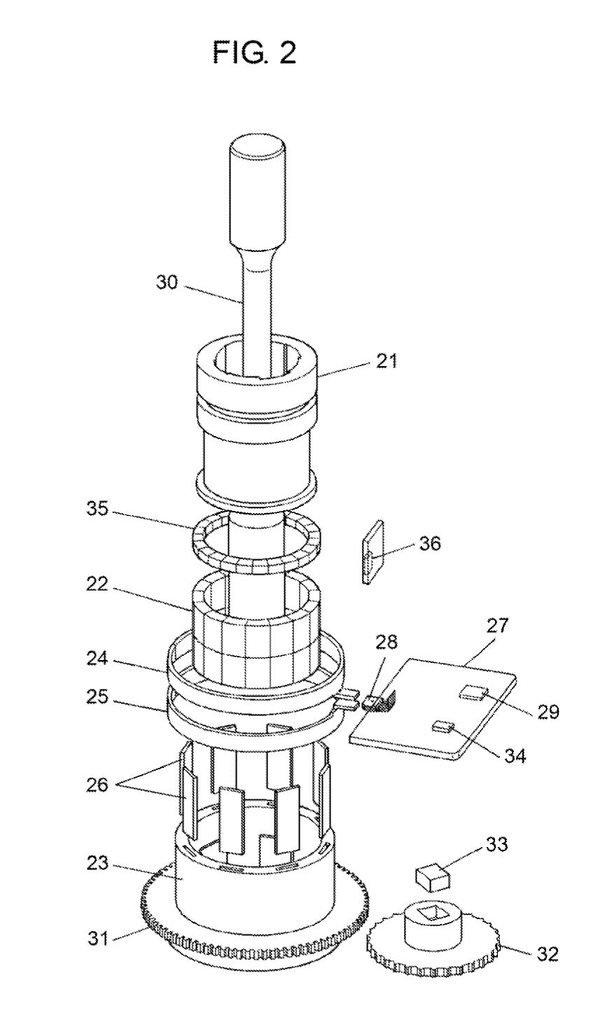

FIG. 1 is a sectional view of a rotary angle and rotary torque sensing device in accordance with an exemplary embodiment. FIG. 2 is an exploded perspective view of the rotary angle and rotary torque sensing device in accordance with the exemplary embodiment.

As shown in FIGS. 1 and 2, the rotary angle and rotary torque sensing device includes a rotary torque sensor for sensing the rotary torque of a steering shaft, sensing gear 32, magnet 33, magnet 35, magnetism sensing element 34, magnetism sensing element 36, printed circuit board 27, controller 29, and rotary gear 31.

The rotary torque sensor includes first rotator 21, magnet 22, second rotator 23, first magnetic body 24, second magnetic body 25, third magnetic bodies 26, magnetism sensing element 28, and coupler 30.

First rotator 21 is shaped like a cylinder, and is coupled to the steering shaft for rotating together with the steering shaft. First rotator 21 is made of insulating resin, e.g. polybutylene terephthalate. Magnet 22 is shaped like a cylinder and rigidly adheres to a lower portion of an outer circumferential wall of first rotator 21. Magnet 22 is made of ferrite or Nd—Fe—B alloy. Second rotator 23 is shaped like a cylinder and is placed below first rotator 21. Second rotator 23 is made of insulating resin, e.g. polybutylene terephthalate. First rotator 21 is coupled to second rotator 23 via coupler 30.

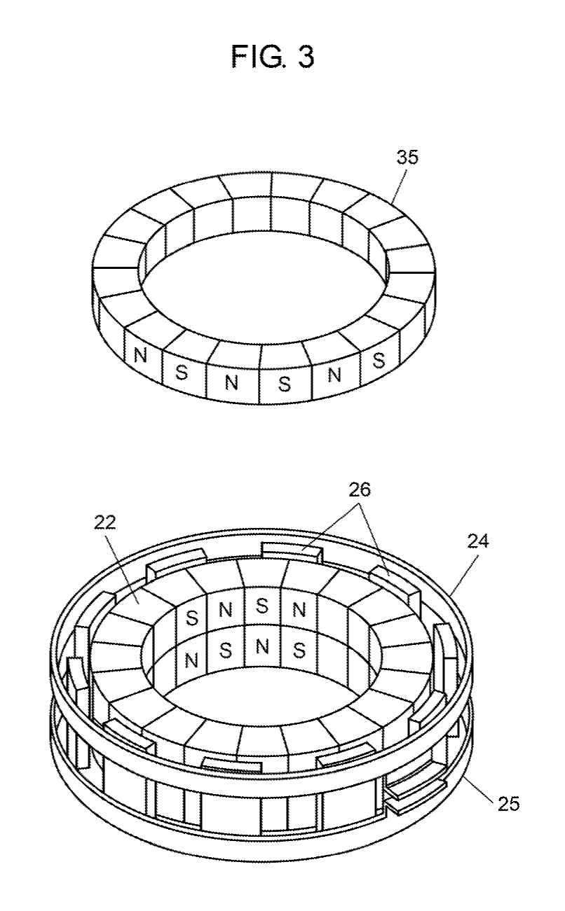

FIG. 3 is a partial perspective view of the rotary angle and rotary torque sensing device in accordance with the exemplary embodiment. As shown in FIG. 3, magnet 22 is divided along the circumferential direction into blocks at equiangular intervals, for instance, magnet 22 is divided into 16 blocks at the intervals of 22.5 degrees. The blocks are then divided into an upper row and a lower row. N-poles and S-poles are arrayed adjacently and alternately to each other both in vertical and lateral directions. To be more specific, in one block, assume that an N-pole is placed at the upper row and an S-pole is placed at the lower row, then in the next block, an S-pole is placed at the upper row and an N-pole is placed at the lower row. Magnet 22 is thus formed of 8 N-poles and 8 S-poles alternately arrayed along the circumferential direction of magnet 22 on the upper row and the same number of N-poles and S-poles arrayed in the same manner on the lower row.

First magnetic body 24, second magnetic body 25, and third magnetic bodies 26 are made of permalloy, Fe, or Ni—Fe alloy. Both of first and second magnetic bodies 24 and 25 are formed by winding a belt-like plate into a ring-like shape, and they are rigidly placed in a housing such that inner walls of first and second magnetic bodies 24 and 25 confront the outer wall of magnet 22. Third magnetic bodies 26 are shaped like a rectangle. Each of third magnetic bodies 26 are placed at equiangular intervals in second rotator 23 by insert-molding or press-fitting. For instance 8 pieces of third magnetic bodies 26 are arrayed radially at 45 degrees intervals in second rotator 23, and they are placed between the outer wall of magnet 22 and each of respective inner walls of first and second magnetic bodies 24 and 25.

Magnetism sensing element 28 includes a Hall element for sensing vertical magnetism and a giant magnetism resistance (GMR) element for sensing horizontal magnetism. Element 28 is mounted on printed circuit board 27 and located between first magnetic body 24 and second magnetic body 25 such that element 28 confronts magnet 22. Between first rotator 21 and second rotator 23, coupler 30, e.g. torsion bar, made of steel and shaped like a pole is placed. First rotator 21 has first connecting section 42 to be connected to coupler 30. Second rotator 21 has second connecting section 43 to be connected to coupler 30. The upper end of coupler 30 is connected to first connecting section 42 of first rotator 21. The lower end of coupler 30 is connected to second connecting section 43 of second rotator 23. Coupler 30 can rigidly adhere to rotators 21 and 23 by connecting coupler 30 directly to first and second connecting sections 42 and 43, or intermediate members 40 and 41 can be used for connecting coupler 30 and each of connecting sections 42 and 43 via each of intermediate members 40 and 41, respectively. This connection may implemented by press-fitting, bonding, or using metal pins.

Printed circuit board 27 is made of insulating material, e.g. paper phenol or glass epoxy, and multiple wiring patterns formed of copper foil are laid on both the faces or one of the faces of board 27, which is placed beside first and second rotators 21 and 23.

Rotary gear 31 is formed on a lower section of an outer circumference of second rotator 23. Sensing gear 32 is made of metal or insulating resin, and includes a spur gear on an outer wall of sensing gear 32. Sensing gear 32 mates with rotary gear 31. Rotary gear 31 is greater than sensing gear in diameter and in number of teeth, e.g. sensing gear 32 having 15 teeth mates with rotary gear 31 having 59 teeth.

Magnet 33 is made of ferrite or Nd—Fe—B alloy and insert-molded at the center of sensing gear 32. Printed circuit board 27 is placed above and substantially in parallel with sensing gear 32. Magnetic sensing element 34 such as anisotropic magnetic resistance (AMR) element, is mounted on printed circuit board 27 at a place facing magnet 33.

Magnet 35 is shaped like a ring and is made of ferrite or Nd—Fe—B alloy. As shown in FIG. 3, N-poles and S-poles are arrayed at given equiangular intervals, e.g. 15 degrees, along the circumferential direction. To be more specific, 12 N-poles and 12 S-poles are arrayed alternately to each other, thereby forming magnet 35. Magnet 35 is rigidly mounted on an upper section of the outer circumferential wall of first rotator 21 with a given space from magnet 22.

Magnetism sensing element 36 is formed of a Hall element for sensing variation of magnetism in a vertical direction and a GMR element for sensing variation of magnetism in a horizontal direction. Magnetism sensing element 36 is placed beside and confronting magnet 35. Rotary gear 31, sensing gear 32, magnet 33, magnetism sensing element 34, magnet 35, and magnetism sensing element 36 constitute a rotary angle sensor.

Controller 29 is mounted on printed circuit board 27 and connected to magnetism sensing element 28. Controller 29 is formed of electronic components, such as a microprocessor. Magnetism sensing elements 34 and 36 are connected to controller 29. The rotary angle and rotary torque sensing device is thus formed.

It is preferable that each one of the magnetism sensing elements be placed free from being affected by magnetism radiated from the magnets or magnetic bodies other than its sensing target. For instance, magnetism sensing elements 34 and 36 are preferably placed away from first magnetic body 24, second magnetic body 25, and third magnetic bodies 26 at given spaces which allow cancelling the magnetic influence from those magnetic bodies.

The rotary angle and rotary torque sensing device discussed above is mounted below a steering wheel of an automobile by rigidly mounting the steering shaft to first rotator 21 and second rotator 23. Controller 29 is coupled to an electronic circuit of the automobile via connectors and lead-wires. The steering shaft can be rigidly mounted to rotators 21 and 23 directly, or intermediate members 40, 41 can be used instead of the direct mounting. The mounting method is not specified here, for instance, the steering shaft can be mounted by press-fitting, bonding, or using metal pins.

Turning the steering wheel in the foregoing structure causes first rotator 21 to rotate and coupler 30 to twist, and then second rotator 23 starts rotating after a small delay from the rotation of first rotator 21. At this time, the delay of second rotator 23 relative to first rotator 21 is small because rotary torque is small when the automobile runs. On the other hand, when the automobile stops the delay is greater because rotary torque is strong.

The rotation of first rotator 21 causes magnet 22 rigidly mounted to rotator 21 to start rotating, and then third magnetic bodies 26 rigidly mounted to second rotator 23 starts rotating with a slight delay from magnet 22. Magnetism sensing element 28 senses magnetic variations of the N-poles and S-poles of magnet 22 via first, second and third magnetic bodies 24, 25, and 26. The values sensed by element 28 are supplied to controller 29.

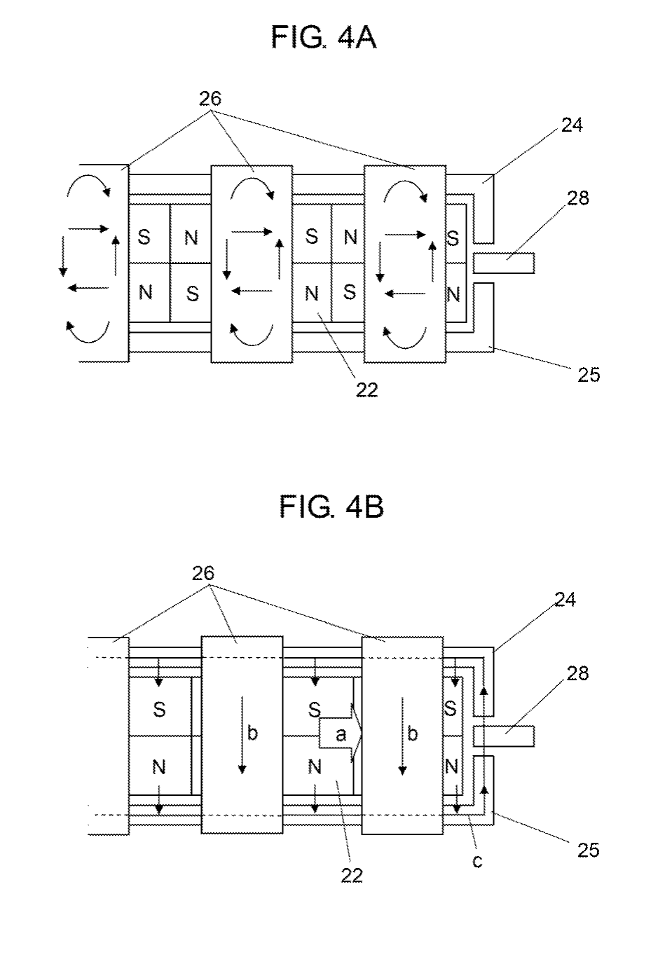

FIG. 4A and FIG. 4B schematically illustrate the rotary angle and rotary torque sensing device in accordance with this exemplary embodiment. In a case where the automobile runs straight with the steering wheel staying at a neutral position, i.e. the steering wheel is not turned, centers of third magnetic bodies 26 confront the centers, i.e. the boundary, between N-poles and S-poles adjacent to each other along the circumferential direction of magnet 22, as shown in FIG. 4A. This structure allows the magnetic force traveling from multiple N-poles to multiple S-poles to be in a balanced state.

As a result, no magnetic flux is produced between first magnetic body 24 and second magnetic body 25 placed outside multiple third magnetic bodies 26. Magnetism sensing element 28 placed between first and second magnetic bodies 24 and 25 thus senses no magnetism.

On the other hand, in the case of turning the steering wheel to the right or the left, the rotation of first rotator 21 causes magnet 22 to start rotating to the right or the left, and second rotator 23 starts rotating to the right or the left with a slight delay from magnet 22. As a result, the center of each third magnetic body 26 shifts from the center of N-pole and S-pole placed adjacently to each other along the circumferential direction of magnet 22.

At this time, magnet 22 generates the magnetic flux on third magnetic bodies 26 such as a closed magnetic circuit from N-pole to S-pole, to be more specific, as shown in FIG. 4B, when magnet 22 rotates along arrow “a” the center of each third magnetic body 26 shifts from the center of N-pole and S-pole adjacent to each other, so that the magnetic flux is generated on third magnetic bodies 26 and this magnetic flux flows from N-pole to S-pole (along arrow “b”) of magnet 22.

At the same time, magnet 22 generates the magnetic flux traveling from respective N-poles to respective S-poles and the magnetic flux is applied to first magnetic body 24 and second magnetic body 25. To be more specific, as shown in FIG. 4B, the magnetic flux flows (denoted by the arrow “c”) from respective N-poles to respective S-poles of magnet 22 via second magnetic body 25 and first magnetic body 24.

The magnetic flux (denoted by the arrow “c”) provides a change in magnetism. Magnetism sensing element 28 senses the sum of this change and outputs a voltage waveform as a torque-sensed signal to controller 29 in response to a magnitude of the sensed magnetism.

The delay of second rotator 23 relative to first rotator 21 is approx. 1 degree when rotary is small, and is approx. 4 degrees when rotary torque is strong. Magnetic sensing element 28 senses weak magnetism when second rotator 23 starts rotating after a small delay relative to first rotator 21 to which magnet 22 is rigidly mounted, whereas element 28 senses strong magnetism when the delay is great.

Controller 29 calculates the rotary torque of the first rotator 21, i.e. the rotary torque of the steering shaft, by using the torque-sensed signal which contains strength and weakness in the magnetism sensed by magnetism sensing element 28, and then controller 29 outputs the rotary torque to the electronic circuit of the automobile.

The rotation of second rotator 23 causes rotary gear 31 formed on the outer wall of second rotator 23 at the lower section, and then sensing gear 32 mating with rotary gear 31 starts rotating.

The rotation of sensing gear 32 causes magnet 33 mounted at the center of gear 32 to start rotating, then the direction of magnetism of magnet 33 is varied, and this variation is sensed by magnetism sensing element 34, which then supplies an angle-sensed signal to controller 29 in a shape of sine-wave, cosine-wave or saw-tooth wave representing repeats of increment or decrement in magnetism.

The rotation of first rotator 21 causes magnet 35, shaped like a ring and rigidly mounted on the outer wall of rotator 21 at an upper section, to start rotating. Magnetism sensing element 36 confronting magnet 35 senses the variation in the magnetism from the N-poles and the S-poles adjacently placed to each other in magnet 35. A voltage waveform in response to the magnitude of the magnetism sensed by element 36 is supplied as an angle-sensed signal to controller 29.

The angle-sensed signal supplied by magnetism sensing element 34 differs from that supplied by magnetism sensing element 36 in data waveform such as tilt angle and shape thereof, so that those signals are supplied to controller 29 as signals having a phase difference.

Controller 29 carries out given calculations based on the angle-sensed signals supplied from magnetism sensing elements 34 and 36, and the numbers of teeth of rotary gear 31 and sensing gear 32. Controller 29 calculates a rough rotary angle at first, and then calculates a detailed rotary angle, and controller 29 supplies the detailed rotary angle to the electronic circuit of the automobile. The electronic circuit calculates the rotary angle and the rotary torque supplied from controller 29 and various data supplied from velocity sensors mounted in the automobile, thereby controlling the automobile, e.g. a power steering device and a braking device.

The electronic circuit controls the power steering device and the braking device in response to a running state or a stopped state of the automobile. For instance, during the running of the automobile, the steering shaft needs small torque, so that the electronic circuit loosens the effectiveness of the power steering device for a driver to turn the steering wheel with a greater force. On the other hand, when the automobile is stopped, the steering shaft needs greater torque, so that the electronic circuit gives the power steering device greater effectiveness for allowing the driver to turn the steering wheel with smaller force.

The electronic circuit also controls the braking device in response to the turning of the steering wheel based on the rotary angle supplied from controller 29. For instance, the electronic circuit makes the effectiveness of the braking device intermittently when the steering wheel is turned by a large angle, whereas it makes the effectiveness of the braking device constantly when the steering wheel is turned in a small angle.

The conventional rotary angle and rotary torque sensing device discussed above needs two sensing gears for sensing a rotary angle, i.e. first sensing gear 13 and second sensing gear 14 of which number of teeth is different from that of first sensing gear 13, thereby making the device bulky.

In this embodiment, magnet 35 is mounted to first rotator 21, and magnetism sensing element 36 senses variation in the magnetism of magnet 35. Controller 29 calculates a rotary angle based on the angle-sensed signal supplied from magnetism sensing element 36 and the angle-sensed signal supplied from magnetism sensing element 34. As discussed above, use of the magnetism from magnet 35 mounted to first rotator 21 as the angle-sensed signal for calculating a rotary angle allows reducing the number of gears, so that the device can be downsized.

In other words, magnetism sensing element 28, which is supposed to sense variation in the magnetism from magnet 22 mounted to first rotator 21, supplies the torque-sensed signal to controller 29, which then calculates rotary torque. Controller 29 calculates the rotary angle based on the angle-sensed signals supplied from magnetism sensing elements 34 and 36. The foregoing mechanism allows the device to sense accurately and positively both of rotary angle and rotary torque with only one sensing gear 32. As a result, the device can be downsized and rotary angle as well as rotary torque can be sensed accurately without fail.

Controller 29 senses both of rotary angle and rotary torque based on the signals supplied from magnetism sensing elements 28, 34, and 36. This structure allows controller 29 to detect an abnormality when any one of magnets 22, 33 and 35, magnetism sensing elements 28, 34, and 36, rotary gear 31, and sensing gear 32 malfunctions or is broken.

For instance, although magnetism sensing elements 28 senses variation in the magnetism caused by a change of rotary torque, magnetism sensing element 34 and magnetism sensing element 36 may output signals which don't correspond to change of rotary angle. In this case, controller 29 can detect either one of magnets 22, 33 and 35, magnetism sensing elements 28, 34, and 36, rotary gear 31, and sensing gear 32 is defective.

It is preferable that magnet 33 and magnet 35 rotate following the rotations of different rotators. That is, rotary gear 31 is disposed to one of first and second rotators 21 and 23, and magnet 35 is mounted preferably to the other of first and second rotators 21 and 23. In this embodiment, magnet 35 mounted to first rotator 21 rotates following the rotation of first rotator 21, and magnet 33 rotates following the rotation of second rotator 23 via rotary gear 31 and sensing gear 32. This structure allows detecting malfunctions in the rotating mechanisms discussed above. Two angle-sensed signals detected from magnets 33 and 35 are generated by the rotations of the rotators different from each other, so that comparing and calculating these two signals allow finding a rotary torque value. A comparison between the rotary torque value and the torque-sensed signal supplied from magnetism sensing element 28 allows detecting malfunctions of the rotary torque sensor.

It is preferable that each plate of third magnetic bodies 26 confronting magnet 22 be shaped like a rectangle, and first magnetic body 24 and second magnetic body 25 be shaped like a belt-type ring. These shapes provide the magnetic bodies at an excellent yield and within short time by cutting or bending plate members of given dimensions. As a result, the rotary angle and rotary torque sensing device can be manufactured at a lower cost.

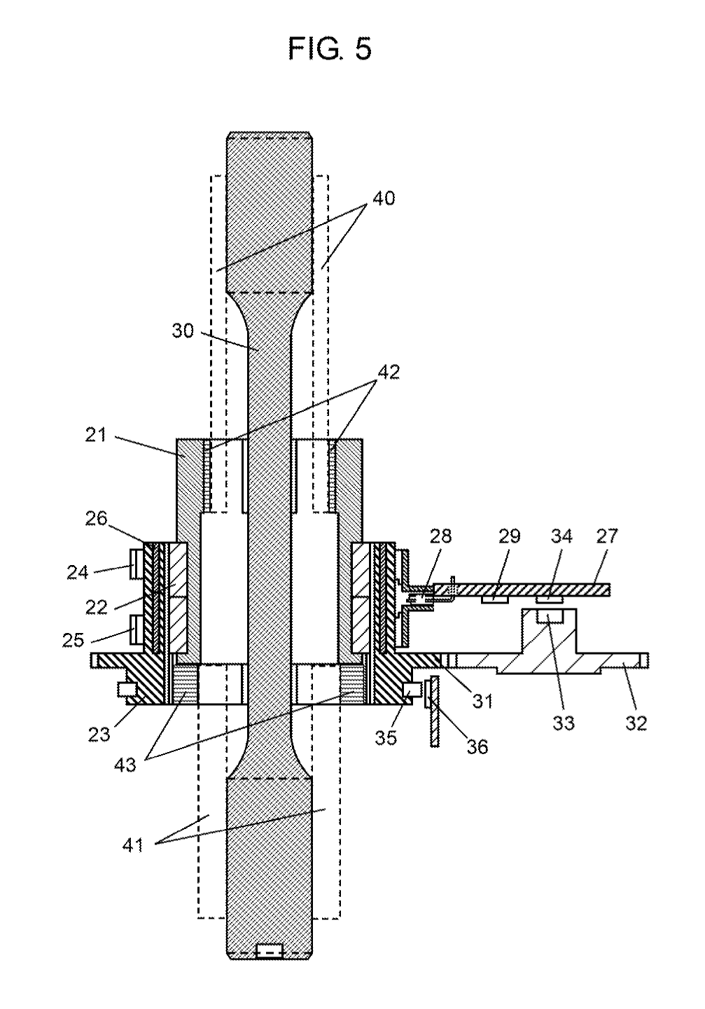

FIG. 5 is a sectional view of another rotary angle and rotary torque sensing device in accordance with another exemplary embodiment. As discussed previously, magnet 35 is mounted to first rotator 21; however, the present embodiment does not limit the structure as in the previous embodiment. For instance, as shown in FIG. 5, magnet 35 can be mounted to second rotator 23, and magnetism sensing element 36 can be placed to confront magnet 35. This structure also allows sensing a rotary angle and rotary torque.

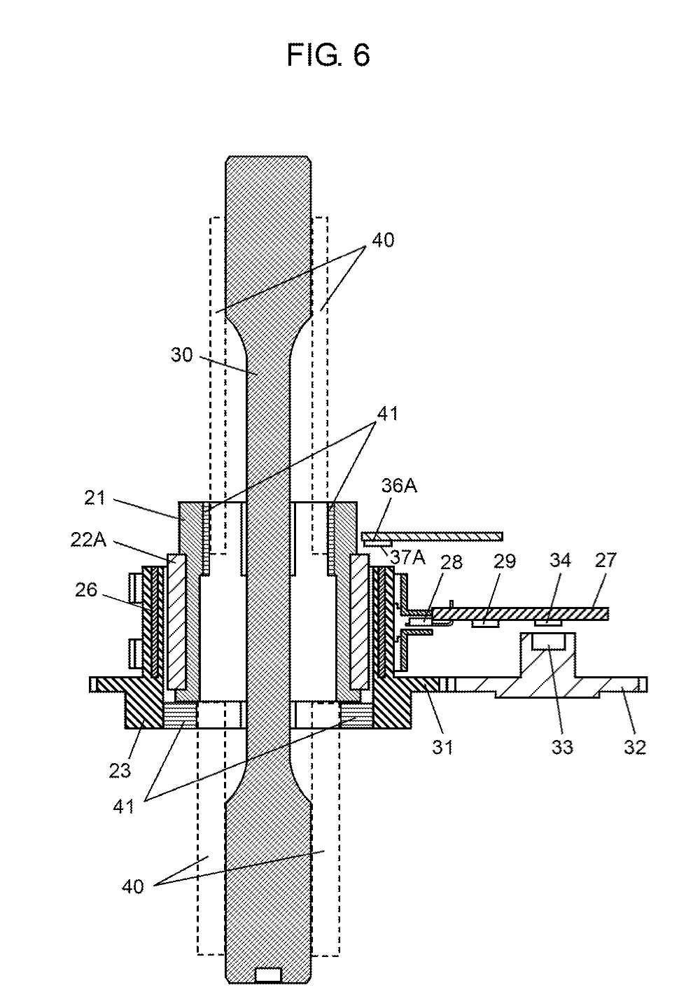

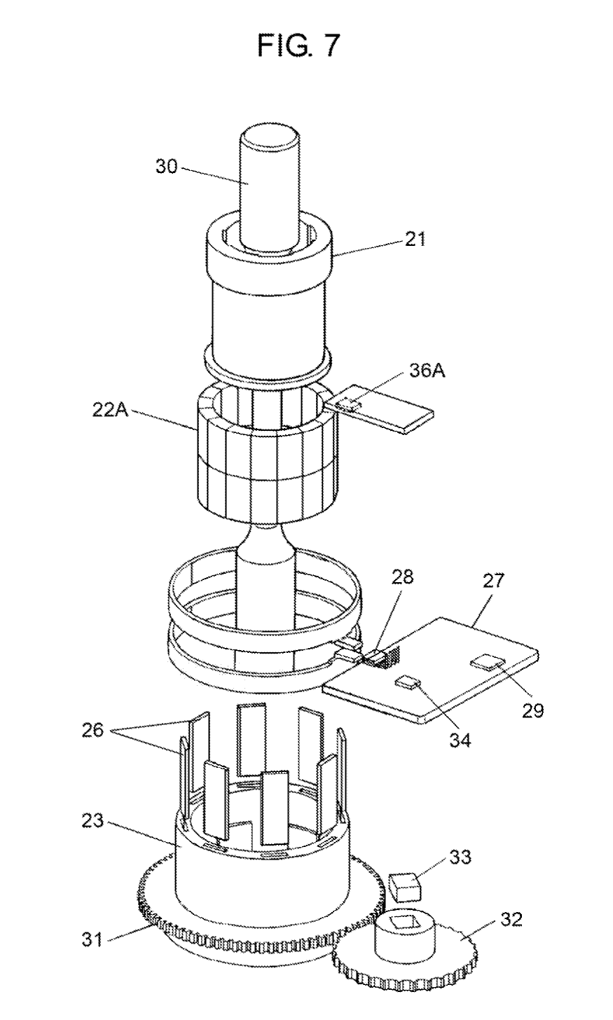

FIG. 6 is a sectional view of a rotary angle and rotary torque sensing device in accordance with another exemplary embodiment. FIG. 7 is an exploded perspective view of this rotary angle and rotary torque sensing device.

In the rotary angle and rotary torque sensing device shown in FIGS. 6 and 7, magnet 22A has an end confronting third magnetism sensing element 36A, and the end of magnet 22A is closer to third magnetism sensing element 36A than any portion of third magnetic bodies 26 is. The rotary angle and rotary torque sensing device does not have magnet 35 but has magnet 22A that is formed by extending upward magnet 22 discussed previously. To be more specific, magnet 22A is formed such that the upper end thereof is located above the upper end of third magnetic bodies 26.

In other words, the rotary angle and rotary torque sensing device shown in FIGS. 6 and 7 employs magnet 22A instead of magnet 35 and magnet 22. On top of that, magnetism sensing element 36A senses the magnetism from magnet 22A, and supplies an angle-sensed signal to controller 29. Magnetism sensing element 34 senses the magnetism from magnet 33 mounted to sensing gear 32 mating with rotary gear 31, and supplies an angle-sensed signal to controller 29. Using the angle-sensed signals supplied from elements 34 and 36A, controller 29 senses a rotary angle of the steering shaft. The foregoing structure reduces the number of components of the rotary angle and rotary torque sensing, so that the device can have a simple structure and be manufactured at a lower cost.

This sensing device provides a phase difference between the angle-sensed signal supplied from magnetism sensing element 34 and the angle-sensed signal supplied from magnetism sensing element 36A. To obtain this phase difference, the following structure is employed: Cylindrical magnet 22A is divided at equiangular intervals of 22.5 degrees into 16 sections circumferentially, i.e. 8 N-poles and 8 S-poles are alternately and adjacently arrayed in one row, and the two rows, namely an upper row and a lower row, are formed. Rotary gear 31 has 34 teeth, and sensing gear 32 has 13 teeth.

Since the rotary angle and rotary torque sensing device discussed above can eliminate magnet 35, the number of components can be further reduced. On top of that, controller 29 calculates the rotary torque of the steering shaft based on a torque-sensed signal supplied from magnetism sensing element 28 which is supposed to sense the magnetism from magnet 22A mounted to first rotator 21. Controller 29 also calculates the rotary angle of the steering shaft based on angle-sensed signals supplied from magnetism sensing elements 34 and 36A. As a result, the foregoing rotary angle and rotary torque sensing device can sense positively the rotary torque and rotary angle with a simpler structure.

Magnet 22A is preferably formed such that its upper end is located above the upper end of third magnetic bodies 26. This structure allows magnetism sensing element 36A, which senses the magnetism from magnet 22A, to resist being affected by the magnetism from third magnetic bodies 26. As a result, the rotary angle can be sensed more accurately and more positively.

Magnetism sensing element 36A is preferably spaced out from third magnetic bodies 26 at a given interval, in particular, magnetism sensing element 36A is desirable placed at a position avoiding influence of the magnetism from third magnetic bodies 26. Magnetism sensing element 36A is desirably placed such that sensing face 37A confronts the top face of magnet 22A along the rotary axis of first rotator 21 so that element 36A can resist being affected by the magnetism from third magnetic bodies 26. This structure allows the rotary angle to be sensed more positively and more accurately.

In the foregoing discussion, rotary gear 31 is formed on the outer wall of second rotator 23 at the lower section, and rotary gear 31 is mated with sensing gear 32; however, the rotary angle and rotary torque sensing device is not limited to this structure.

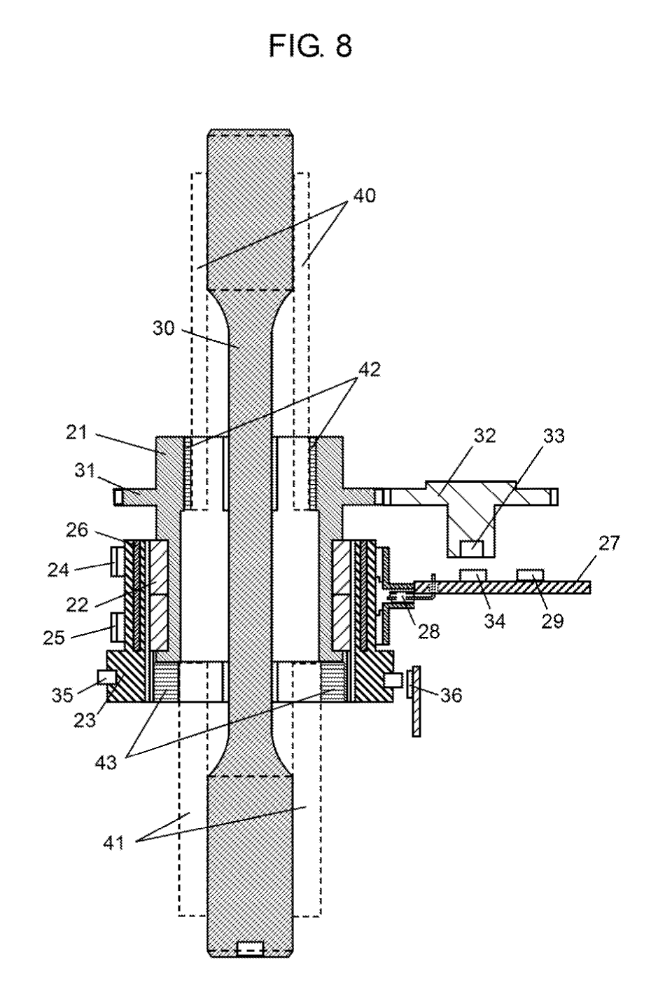

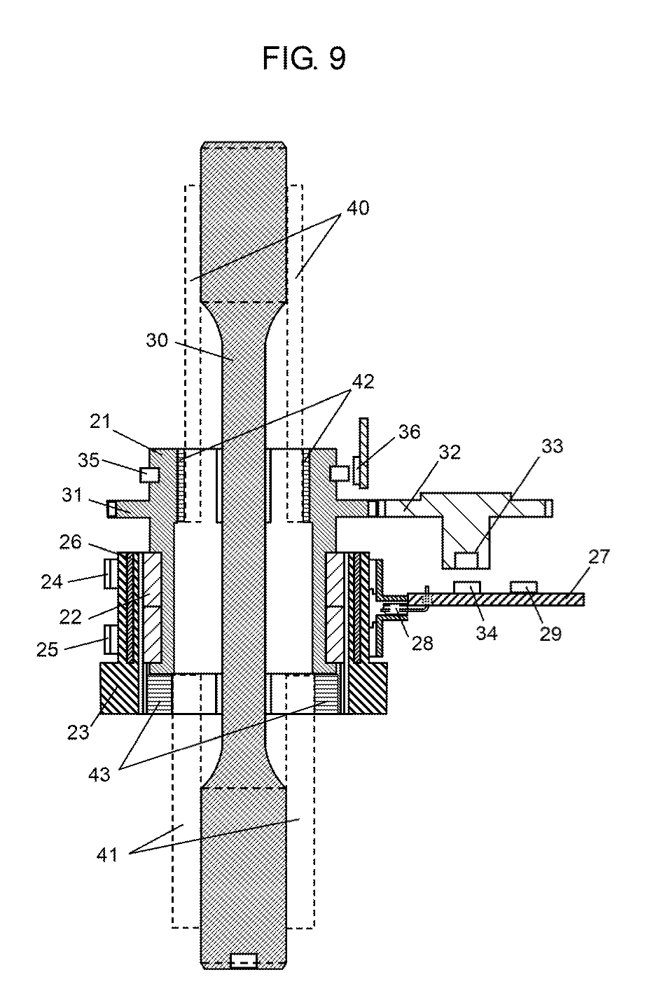

FIG. 8 is a sectional view of another rotary angle and rotary torque sensing device in accordance with another exemplary embodiment. FIG. 9 is a sectional view of this rotary angle and rotary torque sensing device in accordance with the exemplary embodiment. As shown in FIG. 8, magnet 35 is mounted to second rotator 23. Rotary gear 31 is formed on first rotator 21, and mates with sensing gear 32. This structure also allows sensing the rotary torque and the rotary angle.

As shown in FIG. 9, magnet 35 is mounted to first rotator 21, and rotary gear 31 is formed on first rotator 21. Sensing gear 32 mates with rotary gear 31. This structure also allows sensing the rotary torque and the rotary angle.

In the previous discussion, controller 29 is mounted on printed circuit board 27 together with magnetism sensing elements 28 and 34; however, the controller is not limited to this structure. For instance, controller 29 can be mounted on the electronic circuit provided to the automobile, and each of the magnetism sensing elements can be connected to this controller 29 for sensing the rotary angle and rotary torque of the steering shaft.

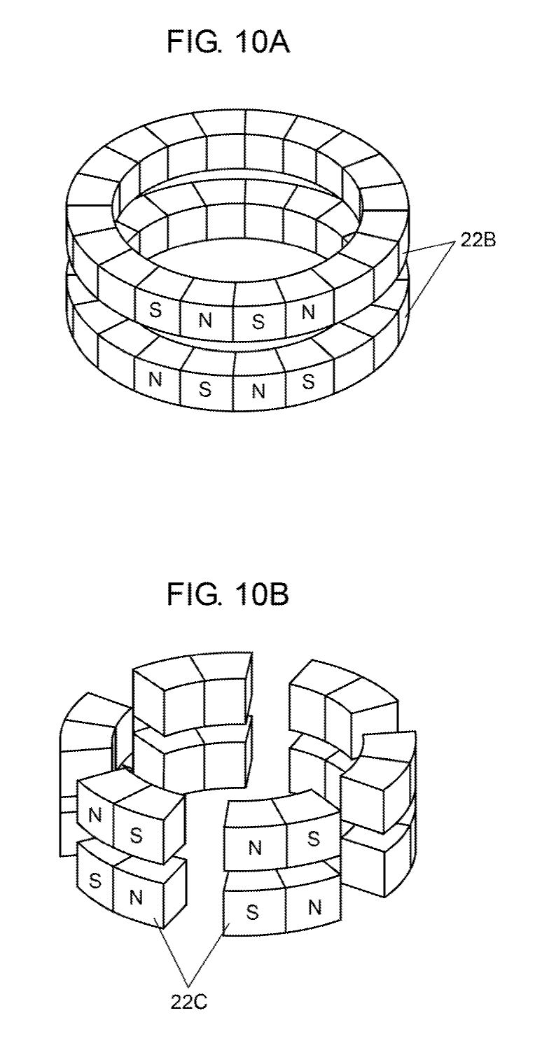

FIG. 10A and FIG. 10B are partial perspective views of the rotary angle and rotary torque sensing device in accordance with another exemplary embodiment. In the previous discussion, multiple N-poles and S-poles are adjacently and alternately arrayed in a lateral direction and a vertical direction to form cylindrical magnet 22 or 22A. However, the rotary angle and rotary torque sensing device is not limited to this structure.

For instance, as shown in FIG. 10A, N-poles and S-poles are arrayed alternately and adjacently to form ring-shaped magnet 22B, and two magnets 22B are piled up, or as shown in FIG. 10B, arc-shaped magnet 22C formed of N-pole and S-pole adjacently placed is piled up in two rows, and arrayed radially at given equiangular intervals. This embodiment can be demonstrated with this structure.

A rotary torque sensor having a different structure from what is discussed previously in this embodiment can obtain similar advantages to what are discussed above as long as the sensor includes a rotator that can rotate together with a rotary shaft, namely, the steering shaft.

The rotary angle and rotary torque sensing device according to the above exemplary embodiments allows size reduction, and can sense the rotary angle and rotary torque accurately and positively. The rotary angle and rotary torque sensing device is thus useful for sensing a rotary angle and rotary torque of a steering shaft of an automobile.

What is claimed is:

1. A rotary angle and rotary torque sensing device for detecting rotary torque and a rotary angle of a steering shaft, comprising:
a rotary torque sensor configured to sense rotary torque of the steering shaft, the rotary torque sensor including
a first rotator rotating together with the steering shaft, and
a second rotator coupled to the first rotator via a coupler, wherein the first rotator includes a first connecting section to be connected to the coupler, wherein the second rotator includes a second connecting section to be connected to the coupler;
a first magnet mounted to one of the first rotator and the second rotator;
a first magnetism sensing element confronting the first magnet for sensing variation in magnetism radiated from the first magnet;
a rotary gear disposed on one of the first rotator and the second rotator;
a sensing gear mating with the rotary gear;
a second magnet mounted to the sensing gear;
a second magnetism sensing element confronting the second magnet for sensing variation in magnetism radiated from the second magnet; and
a controller coupled to the first magnetism sensing element and the second magnetism sensing element,
wherein the controller senses a rotary angle of the steering shaft based on signals supplied from the first magnetism sensing element and the second magnetism sensing element.

2. The rotary angle and rotary torque sensing device of claim 1,
wherein the rotary torque sensor further includes:
a third magnet mounted to an outer wall of the first rotator; and
a third magnetism sensing element confronting the third magnet for sensing variation in magnetism radiated from the third magnet,
wherein the first magnet is disposed on the outer wall of the first rotator with a given space between the first and third magnets, and
wherein the controller senses the rotary torque based on a signal supplied from the third magnetism sensing element.

3. The rotary angle and rotary torque sensing device of claim 2,
wherein the rotary gear is disposed on the second rotator.

4. The rotary angle and rotary torque sensing device of claim 2,
wherein the rotary torque sensor further includes
a first magnetic body formed by winding a belt-like plate into a ring-shape,
a second magnetic body formed by winding a belt-like plate into a ring-shape, and
a third magnetic bodies shaped like a rectangle, and
wherein the third magnetic bodies are radially placed at given intervals such that each of the third magnetic bodies are placed between an outer wall of the third magnet and each of respective inner walls of the first and second magnetic bodies.

5. The rotary angle and rotary torque sensing device of claim 1,
wherein the first magnet is disposed on an outer wall of the first rotator,
wherein the rotary torque sensor further includes a third magnetism sensing element confronting the first magnet, for sensing variation in magnetism radiated from the first magnet, and
wherein the controller senses the rotary torque based on a signal supplied from the third magnetism sensing element.

6. The rotary angle and rotary torque sensing device of claim 5,
wherein the rotary gear is disposed on the second rotator.

7. The rotary angle and rotary torque sensing device of claim 5,
wherein the rotary torque sensor further includes a first magnetic body and a second magnetic body both of which are formed by winding a belt-like plate into a ring-shape, and a third magnetic bodies shaped like a rectangle; and
wherein the third magnetic bodies are radially placed at given intervals between an outer wall of the first magnet and each of respective inner walls of the first and second magnetic bodies.

8. The rotary angle and rotary torque sensing device of claim 7,
wherein the third magnetism sensing element is disposed to confront the first magnet along a rotary axis of the first rotator.

9. The rotary angle and rotary torque sensing device of claim 8,
wherein the first magnet has an end confronting the third magnetism sensing element, and
wherein the end of the first magnet is closer to the third magnetism sensing element than each of the third magnetic bodies is.

10. The rotary angle and rotary torque sensing device of claim 5,
wherein the third magnetism sensing element confronts the first magnet along a rotary axis of the first rotator.

11. The rotary angle and rotary torque sensing device of claim 1,
wherein the rotary gear is disposed on one of the first and second rotators, and the first magnet is mounted to another of the first and second rotators.
